(19) United States
(12) Patent Application Publication
(10) Pub. No.: US 2023/0245466 A1
(43) Pub. Date: Aug. 3, 2023

(54) Vehicle Lidar System and Object Classification Method Therewith

(71) Applicants: Hyundai Motor Company, Seoul (KR); Kia Corporation, Seoul (KR)

(72) Inventor: Jong Won Park, Seongnam-si (KR)

(21) Appl. No.: 18/055,039

(22) Filed: Nov. 14, 2022

(30) Foreign Application Priority Data
Jan. 28, 2022 (KR) 10-2022-0013290

(51) Int. Cl. G06V 20/58; G06V 10/77; G06V 10/82; G06V 10/762; G01S 17/89; G01S 17/10

(52) U.S. Cl. CPC G06V 20/58; G06V 10/7715; G06V 10/82; G06V 10/762; G01S 17/89; G01S 17/10; G06V 2201/08

(57) ABSTRACT

An embodiment object classification method for use with vehicle LiDAR systems includes projecting a three-dimensional point cloud acquired from an object by a LiDAR sensor into a two-dimensional image by extracting two-dimensional image-based feature information comprising shape information of the object and determining a type of the object by processing the two-dimensional image-based feature information based on a convolutional neural network.

### CROSS-REFERENCE TO RELATED APPLICATIONS

This application claims the benefit of Korean Patent Application No. 10-2022-0013290, filed on Jan. 28, 2022, which application is hereby incorporated herein by reference.

### TECHNICAL FIELD

Embodiments relates to a vehicle LiDAR system and an object classification method therewith.

### BACKGROUND

A light detecting and ranging (LiDAR) system may use a point cloud acquired by a LiDAR sensor to acquire information about objects around that vehicle and use the acquired information to assist the autonomous driving function.

Inaccuracy of object information recognized by the LiDAR sensor may lower reliability of autonomous driving and threaten driver safety. Therefore, research continues to increase the accuracy of object detection.

### SUMMARY

Accordingly, embodiments are directed to a vehicle LiDAR system and an object classification method therewith that substantially obviate one or more problems due to limitations and disadvantages of the related art.

Embodiments provide a vehicle LiDAR system capable of accurately classifying objects detected by a LiDAR sensor, such as a vehicle, a pedestrian, a two-wheeled vehicle, a road boundary, and a bush, and an object classification method therewith.

Embodiments are not limited to the above-mentioned features, and other features of the embodiments can be clearly understood by those skilled in the art to which the embodiments pertain from the following description.

Additional advantages, objects, and features of embodiments of the invention will be set forth in part in the description which follows and in part will become apparent to those having ordinary skill in the art upon examination of the following or may be learned from practice of the invention. The features and other advantages of embodiments of the invention may be realized and attained by the structure particularly pointed out in the written description and claims hereof as well as the appended drawings.

To achieve these features and other advantages and in accordance with the purpose of the invention, as embodied and broadly described herein, there is provided an object classification method with vehicle LiDAR systems, which includes projecting a three-dimensional point cloud acquired from an object by a LiDAR sensor into a two-dimensional image to extract two-dimensional image-based feature information including shape information of the object, and determining the type of the object by processing the feature information based on a convolutional neural network (CNN).

The extracting two-dimensional image-based feature information may include extracting a two-dimensional image of a yz plane by projecting the three-dimensional point cloud in an x-axis direction, extracting a two-dimensional image of a zx plane by projecting the three-dimensional point cloud in a y-axis direction, and extracting a two-dimensional image of an xy plane by projecting the three-dimensional point cloud in a z-axis direction.

The extracting two-dimensional image-based feature information may include setting a grid in each of the two-dimensional image of the yz plane, the two-dimensional image of the zx plane, and the two-dimensional image of the xy plane, and storing information on at least one physical quantity required for computing the shape information of the object in a grid cell of the grid.

The setting a grid in each of the two-dimensional image of the yz plane, the two-dimensional image of the zx plane, and the two-dimensional image of the xy plane may include setting a grid of the same N×M dimension in each of the two-dimensional images.

The storing information on at least one physical quantity required for computing the shape information of the object in a grid cell of the grid may include checking a vertical distance between points included in each grid cell and that projection plane and storing a value of the largest vertical distance in each grid cell to create a first specific information map, storing a value of the smallest vertical distance in each grid cell to create a second specific information map, and storing the number of points included in each grid cell to create a third feature information map.

The determining the type of the object by processing the feature information based on a convolutional neural network (CNN) may include determining the type of the object as at least one of a passenger vehicle, a commercial vehicle, a road boundary, a pedestrian, and a two-wheeled vehicle.

The CNN may include a depth-wise separable convolution block.

In another aspect of embodiments, there is provided a non-transitory computer-readable medium recording a program for executing an object classification method with vehicle LiDAR systems, the program being configured to implement a function of projecting a three-dimensional point cloud acquired from an object by a LiDAR sensor into a two-dimensional image to extract two-dimensional image-based feature information including shape information of the object, and a function of determining the type of the object by processing the feature information based on a convolutional neural network (CNN).

In a further aspect of embodiments, there is provided a vehicle LiDAR system that includes a LiDAR sensor and a LiDAR signal processing device configured to project a three-dimensional point cloud acquired from an object by the LiDAR sensor into a two-dimensional image to extract two-dimensional image-based feature information including shape information of the object and to determine the type of the object by processing the feature information based on a convolutional neural network (CNN).

The LiDAR signal processing device may extract a two-dimensional image of a yz plane by projecting the three-dimensional point cloud in an x-axis direction, extract a two-dimensional image of a zx plane by projecting the three-dimensional point cloud in a y-axis direction, and extract a two-dimensional image of an xy plane by projecting the three-dimensional point cloud in a z-axis direction.

The LiDAR signal processing device may set a grid in each of the two-dimensional image of the yz plane, the two-dimensional image of the zx plane, and the two-dimensional image of the xy plane, and store information on at least one physical quantity required for computing the shape information of the object in a grid cell of the grid.

Each of the two-dimensional images may have a grid of the same N×M dimension.

The LIDAR signal processing device may check a vertical distance between points included in each grid cell and that projection plane and store a value of the largest vertical distance in each grid cell to create a first specific information map, store a value of the smallest vertical distance in each grid cell to create a second specific information map, and store the number of points included in each grid cell to create a third feature information map.

The type of the object may include at least one of a passenger vehicle, a commercial vehicle, a road boundary, a pedestrian, and a two-wheeled vehicle.

The CNN may include a depth-wise separable convolution block.

It is to be understood that both the foregoing general description and the following detailed description of embodiments are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this application, illustrate embodiments of the invention and together with the description serve to explain the principle of embodiments of the invention. In the drawings:

FIG. 1 is a schematic block diagram of a vehicle LiDAR system according to an embodiment;

FIG. 2 is a schematic flowchart illustrating an object detection method with vehicle

LiDAR systems according to an embodiment;

FIG. 3 is a flowchart illustrating a method of extracting CNN characteristic information according to an embodiment;

FIGS. 4 to 6 are diagrams for explaining the method of extracting CNN characteristic information in FIG. 3;

FIG. 7 is a diagram illustrating a result of creating a 2D image from a vehicle point cloud according to an embodiment;

FIG. 8 is a diagram illustrating a result of creating a characteristic map based on the 2D image of FIG. 7;

FIG. 9 is a diagram illustrating a CNN structure according to an embodiment; and

FIGS. 10 to 12 illustrate results of performance experiments of an object classification method according to a comparative example and an example.

### DETAILED DESCRIPTION OF ILLUSTRATIVE EMBODIMENTS

The present disclosure will now be made in detail to the preferred embodiments, examples of which are illustrated in the accompanying drawings. The examples, however, may be embodied in different forms and should not be construed as being limited to the embodiments set forth herein. Rather, these embodiments are provided so that this disclosure will be thorough and complete, and will fully convey the scope of the disclosure to those skilled in the art.

In the following description, it will be understood that, when an element is referred to as being formed “on” or “under” another element, it may be directly “on” or “under” the other element or be indirectly formed with one or more intervening elements therebetween.

In addition, it will be understood that “on” or “under” the element may mean an upward direction and a downward direction of the element.

Relational terms such as “first” and “second” and “on”/“up”/“above” and “under”/“down”/“beneath” herein may also be used to distinguish one entity or element from another without necessarily requiring or implying any physical or logical relationship or order between such entities or elements.

Throughout the specification, it will be understood that when a component is referred to as “comprising”/“including” any component, it does not exclude other components, but can further comprise/include the other components unless specified otherwise. In order to clearly illustrate embodiments in the drawings, parts irrelevant to the description may be omitted in the drawings, and like reference numerals refer to like elements throughout the specification.

In embodiments, it is possible to improve accuracy in object classification since a convolutional neural network (hereinafter, referred to as “CNN”) is used during object classification with a vehicle LiDAR system. The CNN is a widely used deep learning technology that may convolute a filter on an input image and repeat a process of extracting features of the image to recognize an object included in the image.

In the present embodiments, the CNN may be used for object classification by extracting feature information of an object that may be input to the CNN from light detection and ranging (LiDAR) data acquired by a LiDAR sensor. In the present embodiments, implementing lightweight CNN computation may significantly reduce an amount of computation, thereby making it easier to apply to a system with limited resources for computation, such as a vehicle.

Hereinafter, a vehicle LiDAR system and an object detection method therewith according to embodiments will be described with reference to the drawings.

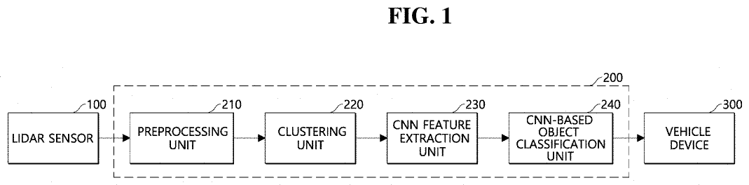

FIG. 1 is a block diagram of the vehicle LiDAR system according to an embodiment.

The vehicle LiDAR system may include a LiDAR sensor 100, a LiDAR signal processing device 200 that processes data acquired by the LiDAR sensor 100 to track a surrounding object and outputs information on the tracked object, and a vehicle device 300 configured to control various functions of a vehicle based on the object tracking information.

The LiDAR sensor 100 may irradiate an object with a laser pulse and then measure a time at which the laser pulse reflected from the object returns within a measurement range, so as to sense information such as a distance to the object, a direction of the object, and a speed. Here, the object may be another vehicle, a person, a thing, or the like external to the vehicle. The LiDAR sensor 100 outputs the sensing result as LiDAR data. The LiDAR data may be output in the form of point cloud data including a plurality of points for a single object.

The LiDAR signal processing device 200 may receive LiDAR data to determine whether there is an object, recognize a shape of an object, track that object, and classify types of recognized objects. The LiDAR signal processing device 200 may include a preprocessing unit 210, a clustering unit 220, a CNN feature extraction unit 230, and a CNN-based object classification unit 240.

The preprocessing unit 210 may select valid data from the types of point data received from the LiDAR sensor wo to preprocess the same in a form that may be processed by the system. The preprocessing unit 210 may convert the LiDAR data to fit a reference coordinate system according to the angle of the position where the LiDAR sensor wo is mounted and may filter points with low intensity or reflectance through the intensity or confidence information of the LiDAR data. The preprocessing unit 210 may perform segmentation on the speed, position, and the like of point data in the process of preprocessing the point data. The segmentation may be a process of recognizing what type of point each point data is. Since this preprocessing of LiDAR data is to refine valid data, some or all of the processing may be omitted or other processing may be added.

The clustering unit 220 groups LiDAR point data into meaningful units according to a predetermined rule, and creates a cluster as a result of the grouping. The clustering may refer to a process of tying segmented points to points for the same object as much as possible. For example, the clustering unit 220 may group LiDAR point data distributed in 3D (three-dimensional) space according to density or may apply vehicle modeling or guardrail modeling to group the outer shape of an object. The clustering unit 220 may create and output a cluster that is a result of grouping, and the output cluster information is in the form of a 3D point cloud.

The CNN feature extraction unit 230 extracts 2D (two-dimensional) image-based feature information that may be input to a CNN from the cluster data output in the form of a 3D point cloud. The CNN feature extraction unit 230 extracts 2D image data by projecting a cluster in the form of a 3D point cloud in three directions of x, y, and z. The CNN feature extraction unit 230 sets a grid in 2D image data and stores a physical quantity that is able to grasp the shape of the 3D point cloud in each grid cell, for example, the distance from a projection plane, the number of points, etc., to create feature information. A method of creating feature information of the CNN feature extraction unit 230 will be described later in more detail.

The CNN-based object classification unit 240 classifies types of objects by processing feature information based on the CNN. The CNN-based object classification unit 240 may classify objects such as a vehicle, a pedestrian, a two-wheeled vehicle, a road boundary, and a bush. The CNN-based object classification unit 240 may classify objects by applying a “depth-wise separable convolution block” without using a general standard convolution block. The “depth-wise separable convolution” is a method of separating all input channels to perform convolution computation for each channel with only one filter and of processing the result again by “1×1 standard convolution” for derivation thereof, which may significantly reduce the amount of computation compared to “standard convolution”. Accordingly, the CNN-based object classification unit 240 of the present embodiment may use the “depth-wise separable convolution block” to process feature information in order to make it easy to apply the CNN technology to vehicle systems with limited system resources. The “depth-wise separable convolution block” applied to the present embodiment may be implemented by applying the configuration of the lightweight convolution block proposed in the depth-wise separable convolution paper “MobileNets: Efficient Convolutional Neural Networks for Mobile Vision Applications,” by A. G. Howard, et al., submitted on Apr. 17, 2017, and accessible at https://arxiv.org/abs/1704.04861(“the MobileNets paper”). Since the “depth-wise separable convolution” is a well-known technology, a detailed description thereof will be omitted.

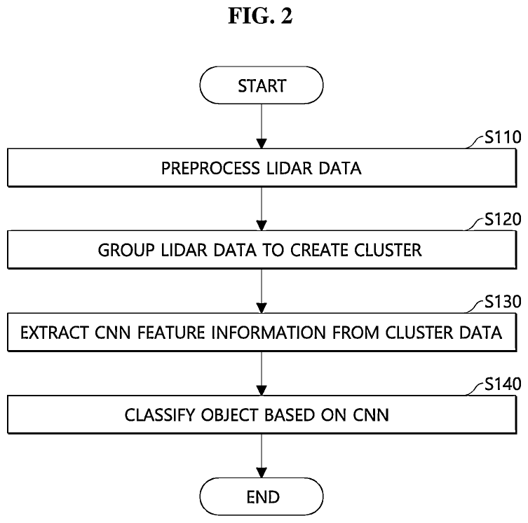

FIG. 2 is a schematic flowchart illustrating an object detection method with vehicle LiDAR systems according to an embodiment.

According to the present embodiment, the method selects valid data from the types of point data received from the LiDAR sensor 100 to preprocess the same in a form that may be processed by the system (S110). In the process of preprocessing, segmentation may be performed on the speed, position, and the like of point data.

The preprocessed LiDAR data is grouped into meaningful units according to a predetermined rule, and a cluster is created as a result of the grouping (S120). Here, the cluster is in the form of a 3D point cloud.

The method extracts 2D image-based feature information that may be input to a CNN from the cluster data output in the form of a 3D point cloud (S130).

The extracted feature information is processed based on the CNN to classify types of objects (S140).

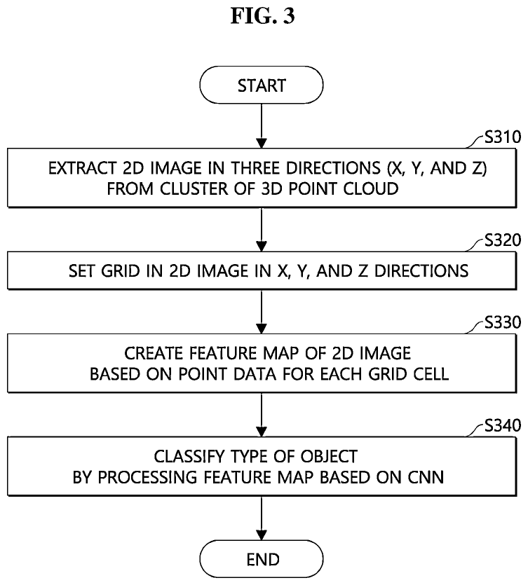

Hereinafter, a method of extracting CNN feature information according to an embodiment will be described in detail with reference to FIGS. 3 to 7. In the present embodiment, the method classifies objects by processing, based on the CNN, cluster information created in the LiDAR system. Since the cluster information created in the LiDAR system is in the form of a 3D point cloud, the present embodiment proposes a method of extracting 2D image-based feature information that may effectively represent the shape of the 3D point cloud.

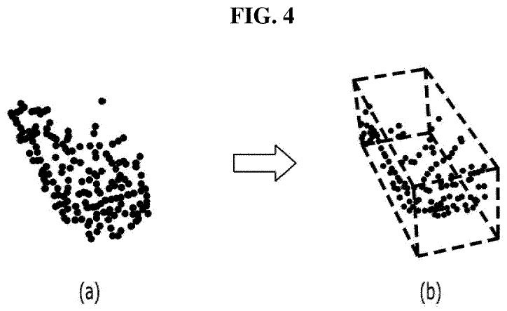

FIG. 3 is a flowchart illustrating a method of extracting CNN characteristic information according to an embodiment. FIGS. 4 to 7 are diagrams for explaining a processing method in each step during extraction of CNN feature information.

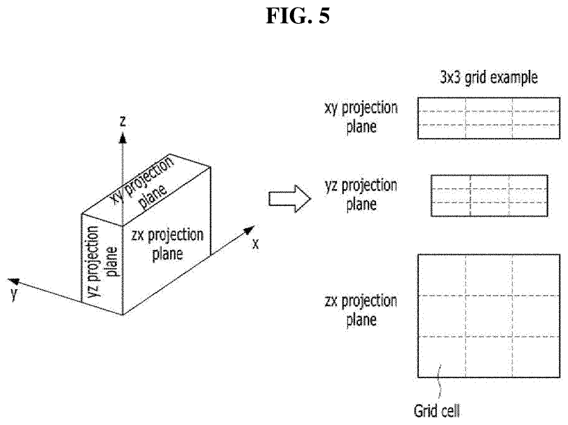

Referring to FIG. 3, in order to extract CNN feature information, 2D image data is extracted by projecting a cluster in the form of a 3D point cloud in three directions of an x-axis, a y-axis, and a z-axis (S310). Step (a) of FIG. 4 illustrates an example of grouping LiDAR point data distributed in 3D space, and step (b) of FIG. 4 illustrates a result of creating a cluster as a result of grouping. The box illustrated in the cluster indicates the boundary of the cluster by creating a virtual box including grouped LiDAR point data. As illustrated in FIG. 4, the cluster information is in the form of a 3D point cloud. In order to represent the shape of this 3D point cloud as a 2D image, 2D image data is extracted by projecting it in three directions of the x-axis, the y-axis, and the z-axis. FIG. 5 is a diagram for explaining a method of projecting a 3D point cloud as 2D image data. The box illustrated in the 3D space of FIG. 5 is a virtual boundary for indicating the boundary of the cluster, and the grouped LiDAR point data may be located inside the box. As such, when the cluster having a 3D coordinate system is projected in the x-axis direction, a 2D image is extracted on the yz plane. When the cluster is projected in the y-axis direction, a 2D image is extracted on the zx plane. When the cluster is projected in the z-axis direction, a 2D image is extracted on the xy plane.

Referring to FIG. 3, a grid is set in the 2D image data extracted by projection in three directions of the x-axis, the y-axis, and the z-axis (S320). As illustrated in FIG. 5, a grid of a preset dimension may be set in each 2D image data extracted on the yz plane, the zx plane, and the xy plane. The embodiment of FIG. 5 illustrates a configuration of a 3×3 grid cell. The images extracted on the respective planes may have different sizes depending on the shape of the cluster. In addition, due to characteristics of LiDAR sensor data, the sizes of the images may be variably detected even for the same object. Accordingly, a grid having the same dimension is set regardless of the size of the extracted 2D image data. As a result, a 3×3 grid cell is set in each 2D image data extracted on the yz plane, the zx plane, and the xy plane. However, the grid cell set in the zx plane where the image is relatively large is large, and the grid cell set in the yz plane where the image is relatively small is small.

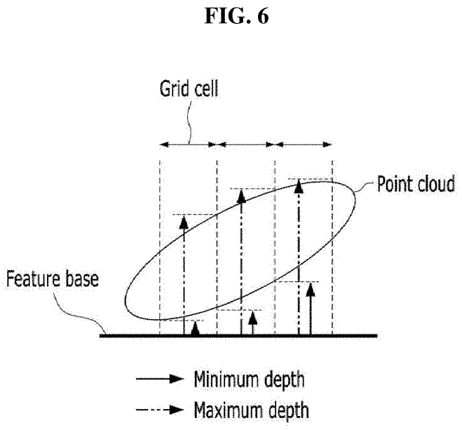

Referring to FIG. 3, after the grid is set in 2D image data, a physical quantity capable of grasping shape information of an object is stored in each grid cell (S330). Feature information may be created by storing a physical quantity, which is calculated to be used as a feature of an object, in each grid cell set in the 2D image data. The physical quantity stored in the grid cell may include the number of points existing in that grid cell, and the maximum and minimum distances between the point cloud and the projection plane. FIG. 6 is a diagram for explaining a method of extracting the physical quantity stored in the grid cell. Referring to FIG. 6, a feature base refers to a plane on which a 2D image is projected. The physical quantity stored in the grid cell considers, as a target, only points existing within that grid cell. For points within the grid cell, the method finds the largest and smallest values of the vertical distance from the projected plane. The largest value of the vertical distance from the projected plane corresponds to a maximum depth, and the smallest value corresponds to a minimum depth. Here, the values of all grid cells of the maximum depth and the minimum depth are normalized to a value between 0 and 1 for use. In addition, the number of points existing in that grid cell is counted and stored in each grid cell. Accordingly, for one 2D image, a feature map of a maximum depth, a feature map of a minimum depth, and feature information of the number of points may be created.

Through the above process, the types of objects are classified by inputting the feature information created based on the 2D image to the CNN (S340, FIG. 3). Accordingly, it is possible to determine whether the object sensed by the LiDAR system is a vehicle, a pedestrian, a two-wheeled vehicle, a road boundary, or a bush.

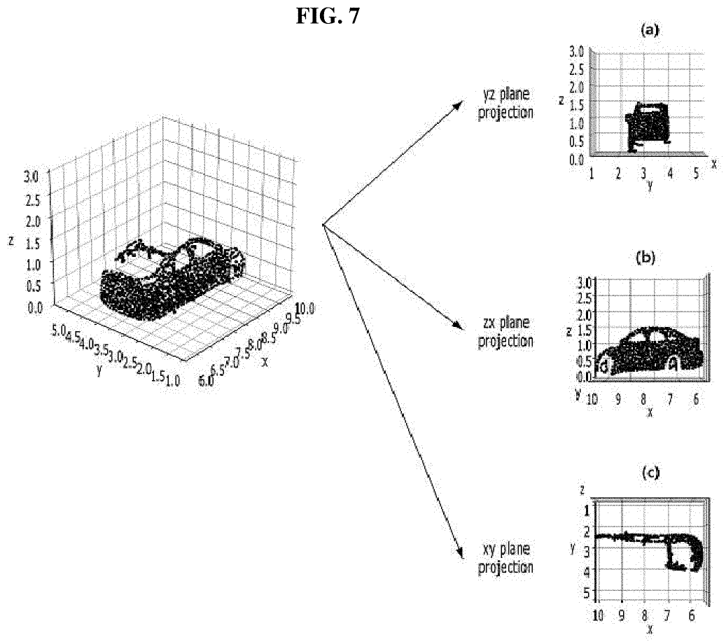

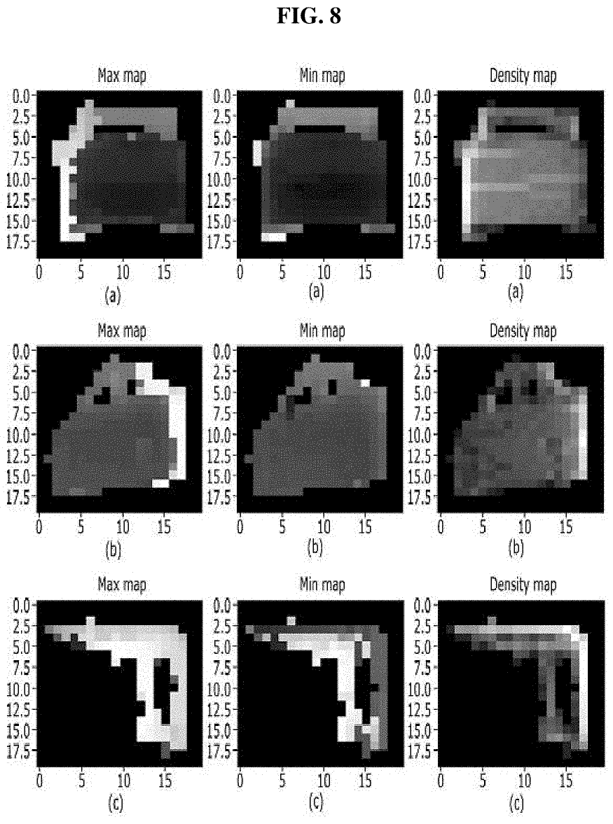

FIG. 7 is a diagram illustrating a result of creating a 2D image from a vehicle point cloud according to an embodiment. FIG. 8 is a diagram illustrating a result of creating a feature map based on the 2D image of FIG. 7.

Referring to FIG. 7, the LiDAR point data acquired from the vehicle may be obtained in the form of a point cloud clustered in the form of the outer shape of the vehicle. In the coordinate system of the point cloud, the traveling direction of the vehicle may be set in the x-axis direction, and the rear line of the vehicle may be set such that it is adjacent to the y-axis and has a height in the z-axis direction.

When the point cloud is projected in the x-axis direction, a 2D image may be extracted on the yz plane as illustrated in graph (a). When the point cloud is projected in the y-axis direction, a 2D image may be extracted on the zx plane as illustrated in graph (b). When the point cloud is projected in the z-axis direction, a 2D image may be extracted on the xy plane as illustrated in graph (c).

FIG. 8 is a diagram illustrating a result of creating a feature map based on the 2D image of FIG. 7.

The grid set for creating the feature map may be set to a 20×20 dimension. The 2D images of graphs (a), (b), and (c) have different sizes, but all 20×20 grid cells are set therefor. For each of these 2D images, a grid map may be created in which feature information of a maximum depth, a minimum depth, and the number of points is stored.

For the 2D image of graph (a) projected on the yz plane, a maximum depth map to store values of the longest vertical distance from the yz plane, a minimum depth map to store values of the closest vertical distance from the yz plane, and a density map to store the number of points for each grid cell are created.

For the 2D image of graph (b) projected on the zx plane, a maximum depth map to store values of the longest vertical distance from the zx plane, a minimum depth map to store values of the closest vertical distance from the zx plane, and a density map to store the number of points for each grid cell are created.

For the 2D image of graph (c) projected on the xy plane, a maximum depth map to store values of the longest vertical distance from the xy plane, a minimum depth map to store values of the closest vertical distance from the xy plane, and a density map to store the number of points for each grid cell are created.

As described above, three 2D images may be extracted in a projection direction from one point cloud, and three feature maps may be extracted for each 2D image.

Then, the types of objects are classified by inputting the feature information created based on the 2D image to the CNN.

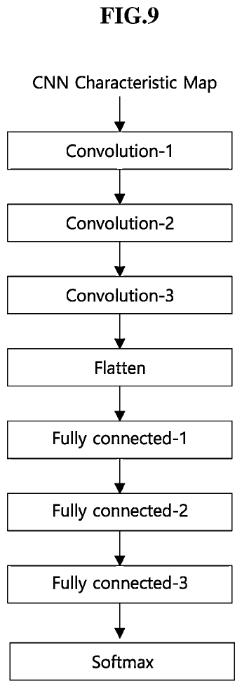

FIG. 9 is a diagram illustrating a CNN structure according to an embodiment.

The CNN according to the embodiment may include a first convolution block (Convolution-1), a second convolution block (Convolution-2), a third convolution block (Convolution-3), a flattening block (Flatten), a first fully connected block (Fully connected-1), a second fully connected block (Fully connected-2), a third fully connected block (Fully connected-3), and a softmax block (Softmax).

The first to third convolution blocks (Convolution-1, Convolution-2, and Convolution-3) serve as filters for extracting important information from the input feature information. The coefficient of the filter of each convolution block may be determined through learning.

The flattening block (Flatten) may flatten matrix-type data output from the convolution block into a one-dimensional array.

The first to third fully connected blocks (Fully connected-1, Fully connected-2, and Fully connected-3) classify images by synthesizing data of all convolution blocks flattened in the form of a one-dimensional array.

The softmax block (Softmax) probabilistically interprets images classified in the fully connected blocks for classification.

Based on the CNN structure above, the input feature information may sequentially pass through the three convolution blocks (Convolution-1, Convolution-2, and Convolution-3) to extract the feature of each part of the 2D image, and may pass through the three fully connected blocks (Fully connected-1, Fully connected-2, and Fully connected-3) to synthesize and aggregate the outputs of the convolution blocks and then output the probability of each class through the softmax block (Softmax).

In the present embodiment, the convolution block is implemented as a “depth-wise separable convolution block” to process feature information. This allows the total computation time to be reduced to about 1/9, and the CNN technology to be easily applied to vehicle systems with limited system resources. The “depth-wise separable convolution block” applied to the present embodiment may be implemented by applying the configuration of the lightweight convolution block proposed in the MobileNets paper.

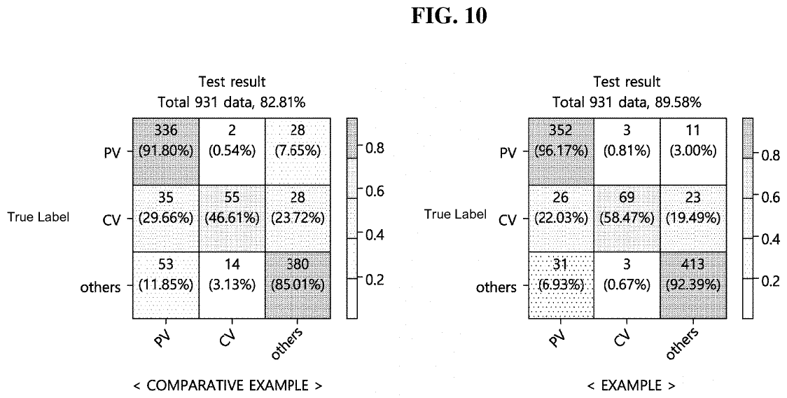

FIGS. 10 to 12 illustrate results of performance experiments of an object classification method according to a comparative example and an example.

FIG. 10 illustrates a result of a quantitative performance comparison experiment of the object classification method according to the comparative example and the example.

According to the comparative example, a user directly creates feature information that is able to represent the shape of an object well (hand-crafted feature) and uses a machine learning technique to learn a classifier. In the comparative example, objects are classified using a small neural network based on a fully connected block (Fully connected layer).

In the example, the classifier was learned by applying a feature map having a size of 10×10.

FIG. 10 illustrates the results of a test for classifying a passenger vehicle (PV) and a commercial vehicle (CV) by application of the comparative example and the example. Referring to FIG. 10, in the example, it can be confirmed that the overall classification performance is increased by about 7% and the proposed classifier shows higher classification accuracy than the prior art in all classes. In particular, it is confirmed that the classification performance is improved by about 12% in CV classification. As a result, it can be confirmed that the classification performance of surrounding vehicles, which are the most important objects in the driving situation of a vehicle, is improved through the classifier proposed in the embodiment.

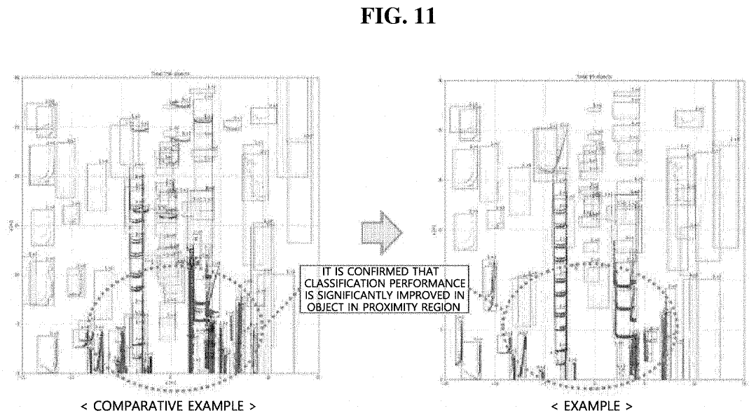

FIG. 11 illustrates the results of a qualitative performance comparison experiment of the object classification method according to the comparative example and the example, and the classification result is checked by displaying the misclassification case.

Passenger vehicles and commercial vehicles as classified by the comparative example and the example are shown. According to the performance verification result of FIG. 11, it can be confirmed that the classification performance of the classifier according to the example is significantly improved in the objects in the proximity region than in the comparative example.

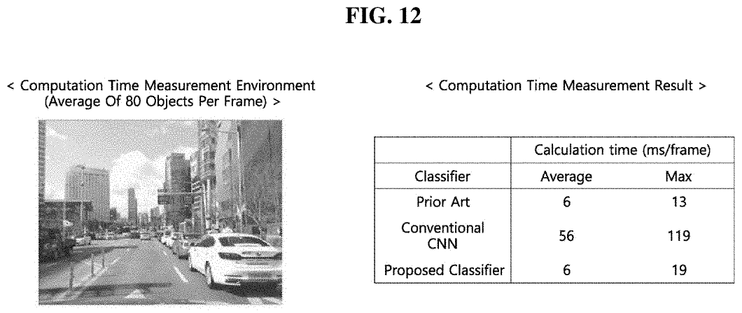

FIG. 12 is a result of comparing the computation times of the comparative example and the example.

In an environment where 80 objects per frame exist by driving a vehicle in an urban environment, the computation time was tested under three conditions.

In the prior art, objects are classified using a small neural network based on a fully connected block (Fully connected layer). The conventional CNN classifies objects using a commonly used convolution block, and the classifier of the embodiment classifies objects by applying a “depth-wise separable convolution block”.

As can be seen from the computation time measurement result table of FIG. 12, an average computation time of 6 ms/frame is required in the prior art. That is, it is preferable that an average computation time of 6 ms/frame or less is required to be applied to a vehicle.

The conventional CNN without weight reduction requires an average computation time of 56 ms/frame. This requires a computation time that is 9 times longer than that of the prior art and is inappropriate for application to a vehicle system.

On the other hand, the structure to which the “depth-wise separable convolution block” of the embodiment is applied may reduce the computation time to about 6 ms/frame on average. Since this is similar to the computation time of the prior art, it can be confirmed that the CNN to which the structure of the embodiment is applied may be applied in a vehicle environment.

As described above, in the present embodiments, the LiDAR object classifier was designed by applying the CNN structure, which was difficult to execute in the existing vehicle system due to the limitation of the amount of computation. To this end, a lightweight CNN structure that applies the “depth-wise separable convolution block” is proposed, and as a result, improved classification performance may be secured through a CNN that has strength in shape recognition.

In addition, the present embodiments propose a method of extracting feature information based on the 2D image for CNN application. Through this, it is possible to reduce the effort required to develop and manage various hand-crafted features among the problems of the prior art.

As is apparent from the above description, according to the vehicle LiDAR system and the object classification method therewith, it is possible to improve accuracy in object classification by classifying objects using the convolutional neural network (CNN), which is a deep learning technology.

According to the vehicle LiDAR system and the object classification method therewith, it is possible to significantly reduce the amount of computation, compared to the existing CNN method, by extracting characteristic information of objects applicable to the CNN from LiDAR data and classifying the objects in the CNN method using the extracted object characteristic information.

Embodiments are not limited to the above-mentioned effects and other effects of embodiments of the present invention can be clearly understood by those skilled in the art to which the present invention pertains from the above description.

While the present disclosure has been described with respect to the embodiments illustrated in the drawings, it will be obvious to those skilled in the art that such embodiments are provided by way of example only. It will be understood by those skilled in the art that various modifications and applications may be made without departing from the spirit and scope of the invention as defined in the following claims. For example, each component specifically illustrated herein may be modified and implemented. Differences related to such modifications and applications should be construed as being included in the scope of the present invention as defined in the appended claims.

What is claimed is:

1. An object classification method for use with vehicle LiDAR systems, the object classification method comprising:
projecting a three-dimensional point cloud acquired from an object by a LiDAR sensor into a two-dimensional image by extracting two-dimensional image-based feature information comprising shape information of the object; and
determining a type of the object by processing the two-dimensional image-based feature information based on a convolutional neural network.

2. The object classification method according to claim 1, wherein extracting the two-dimensional image-based feature information comprises:
extracting a two-dimensional image of a yz plane by projecting the three-dimensional point cloud in an x-axis direction;
extracting a two-dimensional image of a zx plane by projecting the three-dimensional point cloud in a y-axis direction; and
extracting a two-dimensional image of an xy plane by projecting the three-dimensional point cloud in a z-axis direction.

3. The object classification method according to claim 2, wherein extracting the two-dimensional image-based feature information comprises:
setting a grid in each of the two-dimensional image of the yz plane, the two-dimensional image of the zx plane, and the two-dimensional image of the xy plane; and
storing information on a physical quantity required for computing the shape information of the object in a grid cell of the grid.

4. The object classification method according to claim 3, wherein setting the grid in each of the two-dimensional image of the yz plane, the two-dimensional image of the zx plane, and the two-dimensional image of the xy plane comprises setting a grid of a same N×M dimension in each of the two-dimensional images.

5. The object classification method according to claim 3, wherein storing the information on the physical quantity required for computing the shape information of the object in the grid cell of the grid comprises:
checking a vertical distance between points comprised in each grid cell and that projection plane and storing a value of a largest vertical distance in each grid cell to create a first specific information map;
storing a value of a smallest vertical distance in each grid cell to create a second specific information map; and
storing the number of the points comprised in each grid cell to create a third feature information map.

6. The object classification method according to claim 1, wherein determining the type of the object by processing the two-dimensional image-based feature information based on the convolutional neural network comprises determining the type of the object as a passenger vehicle, a commercial vehicle, a road boundary, a pedestrian, or a two-wheeled vehicle.

7. The object classification method according to claim 1, wherein the convolutional neural network comprises a depth-wise separable convolution block.

8. A non-transitory computer-readable storage medium storing a program for executing an object classification method with vehicle LiDAR systems, the program being configured to implement:
a function of projecting a three-dimensional point cloud acquired from an object by a LiDAR sensor into a two-dimensional image by extracting two-dimensional image-based feature information comprising shape information of the object; and
a function of determining a type of the object by processing the two-dimensional image-based feature information based on a convolutional neural network.

9. A LiDAR system for a vehicle, the LiDAR system comprising:
a LiDAR sensor; and
a LiDAR signal processing device configured to:
project a three-dimensional point cloud acquired from an object by the LiDAR sensor into a two-dimensional image by extracting two-dimensional image-based feature information comprising shape information of the object; and
determine a type of the object by processing the two-dimensional image-based feature information based on a convolutional neural network.

10. The LiDAR system according to claim 9, wherein the LiDAR signal processing device is configured to:
extract a two-dimensional image of a yz plane by projecting the three-dimensional point cloud in an x-axis direction;
extract a two-dimensional image of a zx plane by projecting the three-dimensional point cloud in a y-axis direction; and
extract a two-dimensional image of an xy plane by projecting the three-dimensional point cloud in a z-axis direction.

11. The LiDAR system according to claim 10, wherein the LiDAR signal processing device is configured to:
set a grid in each of the two-dimensional image of the yz plane, the two-dimensional image of the zx plane, and the two-dimensional image of the xy plane; and
store information on a physical quantity required for computing the shape information of the object in a grid cell of the grid.

12. The LiDAR system according to claim 11, wherein each of the two-dimensional images has a grid of a same N×M dimension.

13. The LiDAR system according to claim 11, wherein the LIDAR signal processing device is configured to check a vertical distance between points comprised in each grid cell and that projection plane and store a value of a largest vertical distance in each grid cell to create a first specific information map, store a value of a smallest vertical distance in each grid cell to create a second specific information map, and store the number of the points comprised in each grid cell to create a third feature information map.

14. The LiDAR system according to claim 9, wherein the type of the object comprises a passenger vehicle, a commercial vehicle, a road boundary, a pedestrian, or a two-wheeled vehicle.

15. The LiDAR system according to claim 9, wherein the convolutional neural network comprises a depth-wise separable convolution block.
